(19) United States
(12) Patent Application Publication
(10) Pub. No.: US 2006/0113149 A1
(43) Pub. Date: Jun. 1, 2006

(54) Operating mechanism for a parking break

(76) Inventors: Jaume Terradas Prat, Barcelona (ES); Jesus Alvarez Florez, Barcelona (ES); Jord Vidal Jornet, Barcelona (ES); Ismael Callejon I Agramunt, Barcelona (ES)

Correspondence Address: Arnold & Ferrera, 2401 Fountainview, Suite 630, Houston, TX, 77057, US

(21) Appl. No.: 10/524,164

(22) PCT Filed: Aug. 7, 2003
(86) PCT No.: PCT/EP03/08781

§ 371 Date: Dec. 27, 2005

(30) Foreign Application Priority Data
Aug. 7, 2002 (DE) 102 36 216.5

(51) Int. Cl. F16D 65/14

(52) U.S. Cl. 188/2 D

(57) ABSTRACT

The present invention relates to an operating mechanism (1) for operating a of at least one parking brake of a motor vehicle via braking cables (110, 120). The operating mechanism (1) comprises a first driving unit (10, 30, 90) for driving a first actuating element (40) and a second driving unit (60, 80, 100) for driving a second actuating element (50), wherein the second actuating element (50) engages the first actuating element (40). Due to the relative movement of the first actuating element (40) with respect to the second actuating element (50), at least one braking cable (110, 120) is tightened or released for actuating of the at least one parking brake. Further, the invention comprises a method for actuating of parking brakes with the operating mechanism (1), wherein for tightening or releasing of the at least one braking cable (110, 120) the driving units (10, 30, 90, 60, 80, 100) are driven with the same as well as with opposing rotational direction.

### TECHNICAL FIELD

The present invention relates to an operating mechanism for operating a parking brake, particularly a parking brake of motor vehicles preferably driven by an electric motor.

### PRIOR ART

The prior art provides different solutions for parking brakes and handbrakes. Parking brakes for motor vehicles in general act on the back tyres of the vehicle and are activated via a sheated cable. In general the parking brake is actuated by a hand lever. Since the operating of the parking brake partly needs a substantial effort, it is not operated as required by particularly elderly drivers. Therefore, on the one hand a safety risk occurs, since the vehicle could roll away while parking and on the other hand the use of the parking brake is incomfortable. Basically the same effect occurs—however in reduced amount—for the foot actuated parking brakes, also known in the prior art. To reduce this effort and to provide a comfortable operation of the parking brake, parking brakes are suggested in the prior art, which are for example driven by an electric motor instead manually.

So the DE 198 18 339 C1 discloses a braking system in which the brakes are operated via a cable roll, driven by an electric motor. To this end, the ends of the braking cable assemblies of the back tyres are connected to the opposing sides of the circumference of the cable roll. During rotation of the cable roll, equal distances of both braking cables are simultaneously rolled up to the cable roll and thereby the back tyres are uniformly braked. It is a disadvantage to costly adjust the length of the braking cables, in order to guarantee a uniform operation of the brakes. In addition, the braking cables must be checked and adjusted regularly, as they are changed during use.

A further electric parking brake system for passengers cars is described in the WO 98/5663. The document discloses an operating mechanism for parking brakes for passengers cars with an actuating mechanism comprising a motor powered drive, for example an electric motor, for tightening or releasing of a braking cable of a braking system of the vehicle. The operating mechanism comprises an actuator for the braking cable, actuated by the drive, which is related to a force measuring mechanism.

From the DE 197 55 933 an operating mechanism for parking brakes for motor vehicles is known, with an actuator comprising a motor powered drive, for tightening or releasing of braking cable assemblies of a braking system of a vehicle. The drive is connected to an element, that is rotatable around its longitudinal axis, and not displaceable with respect to the longitudinal axis. The element is coupled with a telescopic assembly that is displaceably arranged in direction of the longitudinal axis, wherein the axial length of the telescopic assembly is increased or decreased dependent on the rotational direction of the element. Each of the axial ends of the telescopic assembly is directly or indirectly connected to one braking cable for one brake of the braking system, respectively.

Finally, from the DE 100 43 739.7 a parking brake for motor vehicles is known with at least two braking cable assemblies, comprising an actuator with couple elements, wherein two braking cable assemblies are coupled to this couple element at two couple locations. Further, an operating mechanism is provided, arranged and connected with the actuator in such a way, that the distance of the couple locations can be changed in a controlled manner, whereby a relative movement of the couple locations to or away from each other is enabled.

It is a disadvantage of these constructions, that the operating velocity of the parking brake can just be controlled by the rotational speed of the motor. To achieve different operating velocities, for example a fast tightening of the parking brake and a slow releasing, the motor must be driven with different rotational speeds. To avoid an overload of the motor at too high or too low rotational speeds, it must be dimensioned, so that it also provides the required torque in unfavorable turning velocity ranges. This leads to an over dimensioning of the motor.

It's a further problem, that a drive motor must overcome the complete friction and initial forces of the system during ramp up, thereby consuming a high ramp up current.

The parking brake of a motor vehicle is further a security relevant element, for which a high reliability has to be guaranteed, for example in case of a failure of the drive motor. To this end, the prior art suggests mechanical systems for a manual operation of the parking brake.

Based on the prior art, it is therefore the problem underlying the present invention to provide a parking brake, which can actuate the connected brakes with different operating velocities, that avoids high ramp up currents of the motor and guarantees a high reliability.

### SUMMARY OF THE INVENTION

The present invention solves this problem by a parking brake system for actuating of at least one parking brake of a motor vehicle via brake cables, that are tightened or released by means of a operating mechanism.

The present invention is based on the basic idea of two actuating elements which engage each other and which are separately driven, respectively. An actuation of the brakes connected with the actuating elements is done by a relative movement of the actuating elements to each other. The relative movement of the actuating elements—and, thus the actuating velocity of the brakes—can be controlled in a broad range by means of the separate drive of the respective actuating element according to the invention.

Therefore, the operating mechanism according to the invention preferably comprises a first driving unit for driving a first actuating element as well as a second driving unit for driving a second actuating element wherein the second actuating element engages the first actuating element, and wherein due to the relative movement of the first actuating element with respect to the second actuating element at least one braking cable is tightened or released for actuating of at least one parking brake.

In a first preferred embodiment according to the invention the first actuating element is configured as a nut and the second actuating element is configured as a spindle, wherein the spindle is screwed into the nut.

Therefore, the operating mechanism according to the invention comprises preferably a driving unit for driving the nut and a driving unit for driving the spindle, wherein the spindle is screwed into the nut. Due to the relative movement of the spindle to the nut at least one braking cable is tightened or released for actuating of the at least one parking brake.

The actuating velocity of the parking brake depends on the rotational speed between spindle and nut. By means of the separate drive of the spindle and nut almost any desired actuating velocity can be achieved. Using opposing turning directions very high operating velocities can be achieved, wherein by using the same turning directions but different rotational speeds of spindle and nut, very low operating velocities can be achieved. This is advantageous for a controlled releasing of the parking brake for starting at a hill.

Preferably according to the invention, the driving units each comprise a driving motor respectively, preferably an electric motor. Preferably, one or both of the driving units further comprise a gearbox, which is connected to the driving motor respectively. To avoid high ramp up currents, both driving motors are preferably started in a sequential manner. The high ramp currents of the driving motors then occur temporally shifted, and thus they do not excessively load the board net of the motor vehicle. The later starting driving motor, further had to overcome less friction, as parts of the operating mechanism are already in motion.

The operating mechanism has, due to the redundant configuration of the driving motors, a high reliance. It is also functional, if one driving motor fails. One driving motor is sufficient to actuate the connected brakes in case of an emergency operation.

In a further preferred embodiment, the driving units comprise at least one pinion in each driving unit, for transmitting of a torque from the driving unit to the nut or the spindle. Preferably, each of the driving units further comprise at least one support body, for an axial displacement of the at least one pinion by an axial displacement of nut or spindle. By means of the support bodies, the pinions and the nut or the driving wheel of the spindle are guided so that they align each other. Further preferably, each of the driving units comprise at least one positive shaft connection, for the displaceable support of the at least one driving pinion. By means of these positive connections, rotational motions from the driving motors are transferred to the driving units, wherein the driving units can be axially displaced with respect to the driving motors, that are rigidly mounted within the housing. Preferably, these positive connections comprise splined shaft connections, feather connections or polygon connections. These positive shaft connections allow for a transmitting of a torque by being simultaneously axial displaceable.

According to a further preferred embodiment, the operating mechanism further comprises braking cables, which are connected to the support bodies. A relative axial displacement of the support bodies, due to the screwing of the spindle into the nut, results in a tightening or releasing of the braking cables connected therewith and therefore causes an actuation or releasing of the parking brakes. Since the support bodies are displaceable together with the spindle and nut relative to the driving units, tensile forces on the at least two braking cables can compensate itself. The parking brakes are then actuated with equal force, respectively.

In a further preferred embodiment the operating mechanism comprises a housing.

Further, the present invention solves the underlying problem by a method for actuating of parking brakes, by means of an operating mechanism, that comprises a pair of two actuating elements, engaging each other, wherein a first driving unit drives a first actuating element and a second driving unit drives a second actuating element, and wherein for tightening or releasing of at least one braking cable, the driving units are driven with the same rotational direction as well as with opposing rotational direction. In case of opposed rotational directions of the driving units, high actuation velocities of the parking brake can be achieved and with the same rotational direction slow actuating velocities can be achieved.

In a preferred embodiment of the present invention, the driving units are driven using different rotational speeds. In case of a symmetrical configuration of both driving units, preferred according to the invention, a difference in the rotational speed between first and second actuating element appears.

According to a further preferred embodiment of the method according to the invention, in case of the same rotational direction, the difference in the rotational speed between the first actuating element and the second actuating element determines the velocity, by which the at least one braking cable is tightened or released. By means of the operating mechanism, the tightening and the releasing of the braking cables can therefore be very fast or very slow. Further, unfavorable rotational speeds for the used motors are avoided.

Further preferred embodiments of the invention result from the dependent claims.

### SHORT DESCRIPTION OF THE DRAWING

In the following the preferred embodiments of the present invention are described with reference to the drawing. It shows:

FIG. 1 A preferred embodiment of the operating mechanism according to the invention shown in an open housing;

FIG. 2 schematically a preferred embodiment of the operating mechanism according to the invention.

### DETAILED DESCRIPTION OF THE PREFERRED EMBODIMENTS

A parking brake system for motor vehicles according to the invention comprises at least one parking brake that is tightened or released by the operating mechanism according to the invention via at least one braking cable. The operating mechanism thereby replaces a manual lever or a foot pedal which are normally actuated by the driver of the motor vehicle.

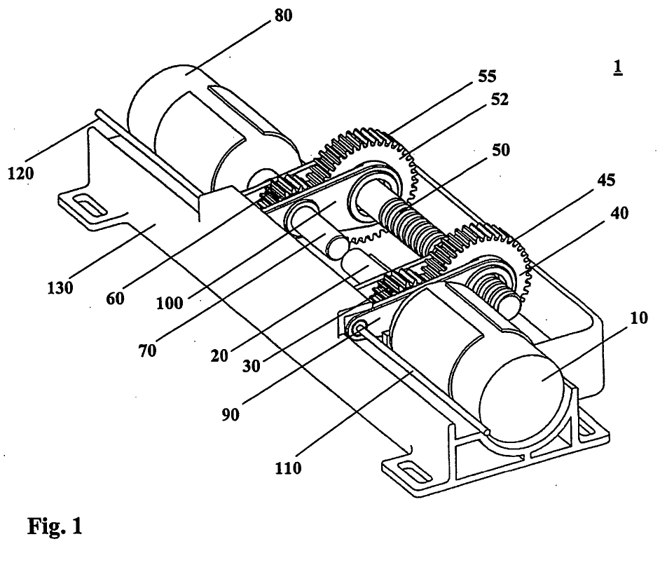

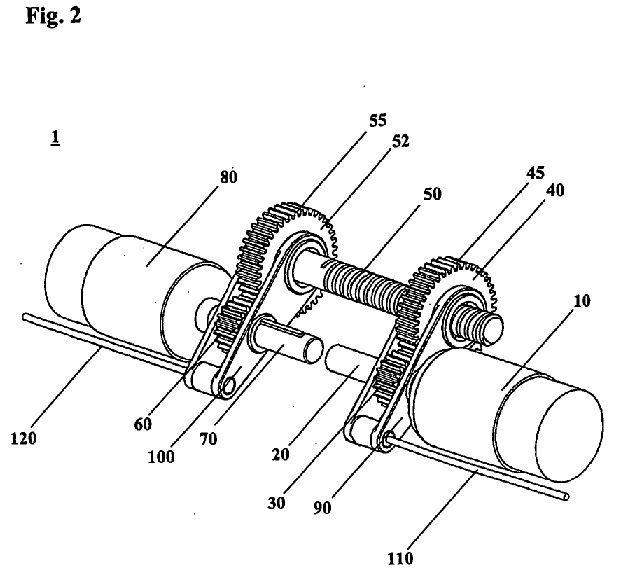

A preferred embodiment of the operating mechanism according to the invention is described in the following with reference to the drawings shown in FIG. 1 and FIG. 2.

In a first preferred embodiment the operating mechanism 1 of the parking brake system comprises a driven nut 40 and a also driven spindle 50 screwed therein. Nut 40 as well as spindle 50 are linearly displaceably mounted relative to a housing 130. At a first support body 90 of the nut 40 a first braking cable 110 is connected. At a second support body 100 of the spindle 50 a second braking cable 120 is connected. The relative movement of spindle 50 to nut 40 causes a linear displacement of both support bodies 90, 100 to or away from each other, so that the braking cables 110, 120, connected thereon for actuating of a brake respectively, are tightened or released.

The operating mechanism 1 is driven by two driving motors 10, 80. In a first preferred embodiment the driving motors 10, 80 are preferably electric motors. Instead of electric motors, also hydraulic motors or pressured air driven motors can be used as driving motors. The driving motors 10, 80 are mounted in a housing 130. For an adaptation of the rotational speed of the driving motors 10, 80, further a gearbox (not shown) can be connected to the driving motors 10, 80 respectively. This gearbox is particularly preferred made as a planetary gear.

Preferably a positive shaft connection 20, 70 is situated onto the output shafts of the driving motors 10, 80, or at the output shafts of the gearboxes where applicable. The driving motors 10, 80 drive via these shaft connections 20, 70 a driving pinion 30, 60 respectively. The shaft-connections 20, 70 can be made as arbitrary positive shaft connections as for example feather-connections, splined-shaft-connections or polygon-connections. Thereby, the driving pinions 30, 60 are driven, wherein they can axially be displaced on the shaft-connections 20, 70.

In this preferred embodiment, the driving pinion 30 engages the outer gearing 45 of the nut 40 and drives the same by means of a rotational motion. The driving pinion 30 and the nut 40 are both supported within the support body 90. It is thereby guaranteed, that the driving pinion 30 is axially displaced together with the nut 40. A first braking cable 110 is preferably mounted at the support body 90.

The drive of the spindle 50 is configured comparable to the drive of the nut 40. The drive pinion 60 engages the outer gearing 55 of the spindle 50. A support body 100 of the spindle 50 assures the axial displacement of the drive pinion 60 is performed together with the spindle 50. A second braking cable 120 is mounted at the support body 100 of the spindle 50.

Metals or high strength plastic materials are used for the above mentioned gearbox elements. The support bodies 90, 100 are preferably made of a sheet metal.

The pair of gears between drive pinion 30 and outer gearing of the nut 45 as well as drive pinion 60 and outer gearing of the spindle 55 is chosen in such a way, that the necessary torque is transmitted to the nut 40 and the spindle 50. The lead of the spindle 50 and the nut 40 as well as the torques of the driving motors 10 and 80 determine the tensile forces that can be applied onto the braking cables 110 respectively 120.

Further embodiments for the above exemplarily described principle of two independently driven and engaging actuating elements are possible. In a further preferred embodiment the independently driven actuating elements are configured as two spindles (not shown) that engage each other at their outer threads. In a further preferred embodiment the actuating element can be preferably provided as a spindle with inner threads (not shown), wherein this spindle engages with a spindle having an outer threads.

With the above described preferred embodiments of an operating mechanism for a parking brake, the braking action runs as follows. A control electronics (not shown) controls rotational speed and rotational direction of the driving motors 10 and 80. To describe the function of the operating mechanism 1 it is first of all assumed, that the drive motors turn with the same rotational speed in opposing rotational direction. This kind of actuation is used for a fast tightening or releasing of the braking cable 110 and 120. The rotational directions described in the following globally relate to the complete operating mechanism. The driving motor 10 is supplied with current from the electronics and turns the driving pinion 30 for example counterclockwise. The nut 40 which engages with the driving pinion 30 by its outer gearing 45, therefore turns clockwise. In case the thread of the nut 40 and the fitting spindle 50 is configured as right-handed threads, the nut 40 is turned into the spindle 50. Thereby the distance between nut 40 and driving wheel 52 of the spindle 50 is reduced.

Simultaneously the second driving motor 80 is preferred according to the invention also supplied with current by the control electronics, so that its output shaft turns for example clockwise. Thereby, the driving pinion 60 turns also clockwise and the outer gearing 55 of the driving wheel 52 of the spindle 50 which is engaged with the driving pinion 60 turns counterclockwise. Due to this motion, the spindle 50 is screwed in the nut 40 and the distance between the wheel 52 of the spindle 50 and the nut 40 is reduced. An opposed rotational motion of the driving motors 80, 10 thus causes a fast screwing in or screwing out of spindle 50 into of out of nut 40.

The support bodies 90 and 100 transmit the distance changes between the nut 40 and driving wheel 52 of the spindle 50 to the braking cables 110 and 120 connected thereto. A reducing of the distance between nut 40 and driving wheel 52 of the spindle 50 causes a tightening of the braking cables 110 and 120 and thereby an actuation of the parking brake. An increasing of the distance between nut 40 and driving wheel 52 of the spindle 50 causes a releasing of the braking cables 110, 120 and thereby a suspension of the braking effect. Due to the displaceable supporting of the complete helical gear on both shaft connections 20, 70 the tensile force on both braking cables 110, 120 is equalized. The normally two brakes of the motor vehicle (not shown) actuated therewith are therefore simultaneously be tightened or released.

By the embodiment of the operating mechanism 1 preferred according to the invention the actuating velocities can be precisely set. In the following it is considered, that in a preferred embodiment the relation of the gear reduction of driving pinion 30 to outer gearing 45 of the nut 40, as well as the relation of gear reduction of the driving pinion 60 to outer gearing 55 of the driving wheel 52 of the spindle 50 are equal. Both driving units 10, 30, 90 or 60, 80, 100 are therefore symmetrically configured.

If a fast actuation of the parking brake is desired, an opposing rotational direction of the driving motors 80, 10 is set. If the parking brake should be actuated slowly and sensitively, the driving motors 10, 80 run with the same rotational direction but different rotational speeds. Depending on which of the driving motors 10, 80 comprises a higher rotational speed, the spindle 50 is screwed into or out of the nut 40. The actuating velocity thus depends on the difference between the rotational speeds of both driving motors 10, 80 and does not depend on their respective absolute rotational speeds. The driving motors 10, 80 can therefore work in its torque optimal range. Too high or too low rotational speeds can be avoided.

High ramp up currents of the driving motors 10, 80 are avoided, by the driving motors not being simultaneously but sequentially be started from the control electronics. The ramp up currents of the driving motors then occur temporally shifted after each other and not at the same time. Thereby, the electric board net of the motor vehicle is not so excessively loaded.

This preferred embodiment further comprises a high reliance. If one of the driving motors 10, 80 should fail, the parking brake can still be actuated by the other driving motor 10, 80, respectively. One driving motor 10, 80 is sufficient to actuate the connected brakes in an emergency mode. A particularly fast or particularly sensitive actuation of the brakes however can then not be guaranteed.

The special construction of these operating mechanism 1 for parking brakes allows to open up new fields of application for parking brakes. The possibility of a fast actuation is particularly preferred for the safe automatic fastening of the brakes to park the motor vehicle. The slow mode of actuation with the same rotational direction of the motors 10, 80 is preferred for the sensitive releasing of the brake to start at a hill.

By the use of an appropriate control, which is connected with the braking pedal of the motor vehicle, a rolling back of the motor vehicle starting at a hill can reliably be avoided by the automatic releasing of the parking brake. The suspension of the braking effect thereby occurs not abruptly, but rather in coordination with the position of the clutch as well as the rotational speed of the motor. In a further preferred embodiment the control of the actuating mechanism can be done using the common board electronics, so that automatic braking and starting actions can be done by means of the parking brake.

List of Reference Signs

1 Operating mechanism

10 First driving motor

20 First shaft connection

30 First driving pinion

40 Nut

45 Outer gearing of the nut

50 Spindle

52 Driving wheel of the spindle

55 Outer gearing of the driving wheel of the spindle

60 Second driving pinion

70 Second shaft connection

80 Second driving motor

90 Support body of the nut

100 Support body of the spindle

110 First braking cable

120 Second braking cable

130 Housing

1. An operating mechanism for actuating at least one parking brake, particularly for motor vehicles, comprising:
a first driving unit for driving a first actuating element; and
a second driving unit for driving a second actuating element characterized in that the second actuating element engages said first actuating element in order to cause a relative movement of the first actuating element with respect to the second actuating element in order to tighten or to release at least one braking cable for actuating of the at least one parking brake.

2. Operating mechanism according to claim 1, wherein the first actuating element is configured as a nut and the second actuating element configured as a spindle, and wherein the spindle is screwed into the nut.

3. Operating mechanism according to claim 1, wherein the driving units each comprise an electric motor and a gearbox.

4. Operating mechanism according to claim 1, wherein the driving units further comprise:
at least one driving pinion in each driving unit for transmitting a torque from the driving unit to the nut or the spindle;
at least one support body in each driving unit for axial displacement of the at least one driving pinion respectively by the axial displacement of nut or spindle; and
at least one shaft connection in each driving unit for the displaceable support of the respectively at least one driving pinion.

5. Operating mechanism according to claim 4, wherein the shaft connections comprise splined shaft connections, feather connections or polygon connections.

6. Operating mechanism according to claim 1, further comprising braking cables that are connected to support bodies.

7. Operating mechanism according to claim 6, wherein the tensile force of the braking cables is compensated due to the displaceable mounting of the driving pinions on the shaft connections.

8. Operating mechanism according to claim 1, further comprising a housing.

9. Method for actuating of parking brakes with an operating mechanism, comprising a pair of two actuating elements, engaging each other in order to cause a relative movement of the actuating elements, wherein a first driving unit drives a first actuating element and a second driving unit drives a second actuating element, and wherein for tightening or releasing of at least one braking cable the driving units are driven with the same as well as with the opposing rotational direction.

10. Method according to claim 9, wherein the driving units are driven with different rotational speeds.

11. Method according to claims 9, wherein at the same rotational direction of the driving units the difference of the rotational speed between the first actuating element and the second actuating element determines the velocity, by which the at least one braking cable is tightened or released.
